(19) United States
(12) Patent Application Publication
(10) Pub. No.: US 2022/0414001 A1
(43) Pub. Date: Dec. 29, 2022

(54) MEMORY INCLUSIVITY MANAGEMENT IN COMPUTING SYSTEMS

(71) Applicant: Microsoft Technology Licensing, LLC, Redmond, WA (US)

(72) Inventors: Ishwar Agarwal, Redmond, WA (US); George Zacharias Chrysos, Portland, OR (US); Oscar Rosell Martinez, Barcelona (ES)

(21) Appl. No.: 17/359,104

(22) Filed: Jun. 25, 2021

(51) Int. Cl. G06F 12/02; G06F 12/0817; G06F 12/084; G06F 12/0831; G06F 13/16

(52) U.S. Cl. CPC G06F 12/0246; G06F 12/0822; G06F 12/084; G06F 12/0833; G06F 13/1673; G06F 2212/466

(57) ABSTRACT

Techniques of memory inclusivity management are disclosed herein. One example technique includes receiving a request from a core of the CPU to write a block of data corresponding to a first cacheline to a swap buffer at a memory. In response to the request, the method can include retrieving metadata corresponding to the first cacheline that includes a bit encoding a status value indicating whether the memory block at the memory currently contains data of the first cacheline or data corresponding to a second cacheline. The first and second cachelines alternately sharing the swap buffer at the memory. When the decoded status value indicates that the memory block at the first memory currently contains the data corresponding to the first cacheline, an instruction is transmitted to the memory controller to directly write the block of data to the memory block at the first memory.

### BACKGROUND

In computing, memory typically refers to a computing component that is used to store data for immediate access by a central processing unit (CPU) in a computer or other types of computing device. In addition to memory, a computer can also include one or more storage devices (e.g., a hard disk drive or HDD) that persistently store data on the computer. In operation, data, such as instructions of an application can first be loaded from a storage device into memory. The CPU can then execute the instructions of the application loaded in the memory to provide computing services, such as word processing, online meeting, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Computing devices often deploy a cache system with multiple levels of caches to facilitate efficient execution of instructions at a CPU. For example, a CPU can include multiple individual processors or “cores” each having levels of private caches (e.g., L1, L2, etc.). The multiple cores of a CPU can also share a system level cache (SLC) via a SLC controller co-packaged with the CPU. External to the CPU, the memory can include both a cache memory and a main memory. A cache memory can be a very high-speed memory that acts as a buffer between the main memory and the CPU to hold cachelines for immediate availability to the CPU. For example, certain computers can include Double Data Rate (DDR) Synchronous Dynamic Random-Access Memory (SDRAM) as a cache memory for the CPU. Such cache memory is sometimes referred to as “near memory” for being proximate to the CPU. In addition to near memory, the CPU can also interface with a main memory via Compute Express Link (CXL) or other suitable types of interface protocols. The main memory can sometimes be referred to as “far memory” due to being at farther distances from the CPU than the near memory.

During operation, cores in the CPU can request data from the multiple levels of caches in a hierarchical manner. For example, when a process executed at a core requests to read a block of data, the core can first check whether L1 cache currently contains the requested data. When L1 does not contain the requested data, the core can then check L2 cache for the same data. When L2 does not contain the requested data, the core can request the SLC controller to check whether the SLC contains the requested data. When the SLC also does not contain the requested data, the SLC controller can request a memory controller of the near or far memory for the block of data. Upon locating the data from the near or far memory, the memory controller can then transmit a copy of the block of data to the SLC controller to be stored at the SLC and available to the core. The SLC controller can then provide the block of data to the process executing at the core via L2 and/or L1 cache.

In certain implementations, the near memory can be used as a swap buffer for the far memory instead of being a dedicated cache memory for the CPU to make the near memory available as addressable system memory. In certain implementations, a ratio between near and far memory can be one to any integer greater than or equal to one. For example, a range of system memory addresses can be covered by a combination of near memory and far memory in a ratio of one to three. As such, the range of system memory can be divided into four sections, e.g., A, B, C, and D, variably corresponding to one memory block in the near memory and three memory blocks in the far memory. Each memory block in the near and far memory can include a data portion (e.g., 512 bits) and a metadata portion (e.g., 128 bits). The data portion can be configured to contain user data or instructions. The metadata portion can be configured to contain metadata having multiple bits (e.g., six to eight bits for four sections) encoding location information of the various sections of the system memory.

Using the metadata in the memory block of the near memory, the memory controller can be configured to manage swap operations among the various sections, e.g., A, B, C, and D. For instance, during a read operation, the memory controller can be configured to read from the near memory to retrieve data and metadata from both the data portion and the metadata portion of the near memory, respectively. The memory controller can then be configured to determine which section of the system memory the retrieved data corresponds to using the metadata, and whether the determined section matches a target section to be read. For instance, when the target section is section A, and the first two bits from the metadata portion contains a code, e.g., (0, 0) corresponding to section A, then the memory controller can be configured to determine that the retrieved data is from section A (referred to as “cacheline A”). Thus, the memory controller can forward the retrieved data from section A to a requesting entity, such as an application or OS executed on the computing device.

On the other hand, when the first two bits from the metadata portion contains a code, e.g., (0, 1) instead of (0, 0), for example, the memory controller can be configured to determine that the retrieved cacheline Belongs to section B (referred to as “cacheline B”), not cacheline A. The memory controller can then continue to examine the additional bits in the metadata to determine which pair of bits contains (0, 0). For example, when the second pair (Bit 3 and Bit 4) of the metadata contains (0, 0), then the memory controller can be configured to determine that cacheline A is located at the first memory block in the far memory. In response, the memory controller can be configured to read cacheline A from the first memory block in the far memory and provide the cacheline A to the SLC controller. The memory controller can then be configured to write the retrieved cacheline A into the near memory and the previously retrieved cacheline B to the first memory block in the far memory, thereby swapping cacheline A and cacheline B. The memory controller can also be configured to modify the bits in the metadata portion in memory block of the near memory to reflect the swapping of cacheline Between section A and section B in the near memory.

Though using the near memory as a swap buffer can increase the amount of addressable system memory in the computing device, such a configuration may negatively impact execution latency due to a lack of inclusivity of the cache system in the computing device. As used herein, the term “inclusivity” generally refers to a guarantee that data present at a lower level of cache (e.g., SLC) is also present in a higher level of cache (e.g., near memory). For instance, when cacheline A is present in SLC, L1, or L2, inclusivity would guarantee that a copy of same cacheline A is also present in the memory block of the near memory. When the near memory is used as a swap buffer, however, such inclusivity may be absent. For example, after reading cacheline A by a process executed by a core, the same or a different process can request to read cacheline B from the near memory. In response, the memory controller can swap cacheline A and cacheline B in the near memory. As such, when a process subsequently tries to write new data to cacheline A, the near memory would contain cacheline B, not cacheline A. Thus, the memory controller may need to perform additional operations such as a read of the metadata in the near memory to determine a current location of cacheline A before performing the write operation. The extra read before write can reduce memory bandwidth, and thus negatively impact system performance in the computing device.

One solution for the foregoing difficulty is to configure the cache system to enforce inclusivity at all levels of caches via back invalidation. As such, in the previous example, when the near memory contains cacheline B instead of cacheline A, the cache system would invalidate all copies of cacheline A in SLC, L1, and/or L2 in the computing device. Such invalidation can introduce substantial operational complexity and increase execution latency because cacheline A may include frequently used data that the process needs to access. Thus, after cacheline A is invalidated to enforce inclusivity because the swap in near memory, the process may be forced to request another copy of cacheline A from the near memory to continue execution. The additional read for cacheline A may further reduce memory bandwidth in the computing device.

Several embodiments of the disclosed technology can address the foregoing impact on system performance when implementing the near memory as a swap buffer in the computer device. In certain implementations, sections of data, e.g., A, B, C, and D that share a memory block of near memory used as a swap buffer can be grouped into a dataset (e.g., referred to as T1set). A hash function can be implemented at, for example, the SLC controller such that all A, B, C, and D sections of T1set is hashed to be stored in a single SLC memory space (referred to as a SLC slice). In certain implementations, data for the different sections stored at the SLC slice can include a cache set having both a tag array and a data array. The data array can be configured to store a copy of data for the A, B, C, D sections. The tag array can include multiple bits configured to indicate certain attributes of the data stored in the corresponding data array.

In accordance with several embodiments of the disclosed technology, the tag array can be configured to include a validity bit and an inclusivity bit for each of the A, B, C, D sections. In other embodiments, the tag array can include the inclusivity bit without the validity bit or having other suitable configurations. Using the validity and inclusivity bits, the SLC controller can be configured to monitor inclusivity status in the cache system and modify operations in the computing device accordingly. For example, upon a read for cacheline A from the near memory, the SLC controller can set the validity bit and the inclusivity bit for section A as true (e.g., set to a value of one). The validity bit indicates that the cacheline A stored in the SLC slice is valid while the inclusivity bit indicates that the near memory also contains a copy of cacheline A stored in the SLC slice.

Subsequently, when processing a write to section A with new data, the SLC controller can be configured to retrieve the tag array from the SLC slice and determine whether the inclusivity bit for section A is true. Upon determining that the inclusivity bit for section A is true, the SLC controller can be configured to instruct the memory controller to directly write the new data for section A to the swap buffer (i.e., the near memory) because inclusivity is maintained. On the other hand, upon determining that the inclusivity bit for section A is not true, the SLC controller can be configured to provide the new data for section A to the memory controller along with an indication or warning that the near memory may not contain cacheline A. Based on the indication, the memory controller can be configured to perform additional operations such as the metadata retrieval and examination operations described above to determine a location for section A in the near or far memory.

Several embodiments of the disclosed technology above can improve system performance of the computing device when the near memory is used as a swap buffer instead of a dedicated cache for the CPU. Using performance simulations, the inventors have recognized that large numbers of memory operations in a computing device do not involve intervening read/write operations. As such, inclusivity at the multiple levels of cache is often maintained even though not strictly enforced. Thus, by using the inclusivity bit to monitor for a status of inclusivity in the cache system, extra read before write operations by the memory controller can be avoided on many occasions. As a result, execution latency and/or other system performance of the computing device can be improved.

### BRIEF DESCRIPTION OF THE DRAWINGS

FIG. 1 is a schematic diagram illustrating a distributed computing system implementing memory inclusivity management in accordance with embodiments of the disclosed technology.

FIG. 2 is a schematic diagram illustrating certain hardware/software components of the distributed computing system of FIG. 1 in accordance with embodiments of the disclosed technology.

FIGS. 3A-3E are schematic diagrams illustrating certain hardware/software components of the distributed computing system of FIG. 1 during example operation stages in accordance with embodiments of the disclosed technology.

FIGS. 4A-4C are flowcharts illustrating certain processes of memory inclusivity management in accordance with embodiments of the disclosed technology.

FIG. 5 is a computing device suitable for certain components of the distributed computing system in FIG. 1.

### DETAILED DESCRIPTION

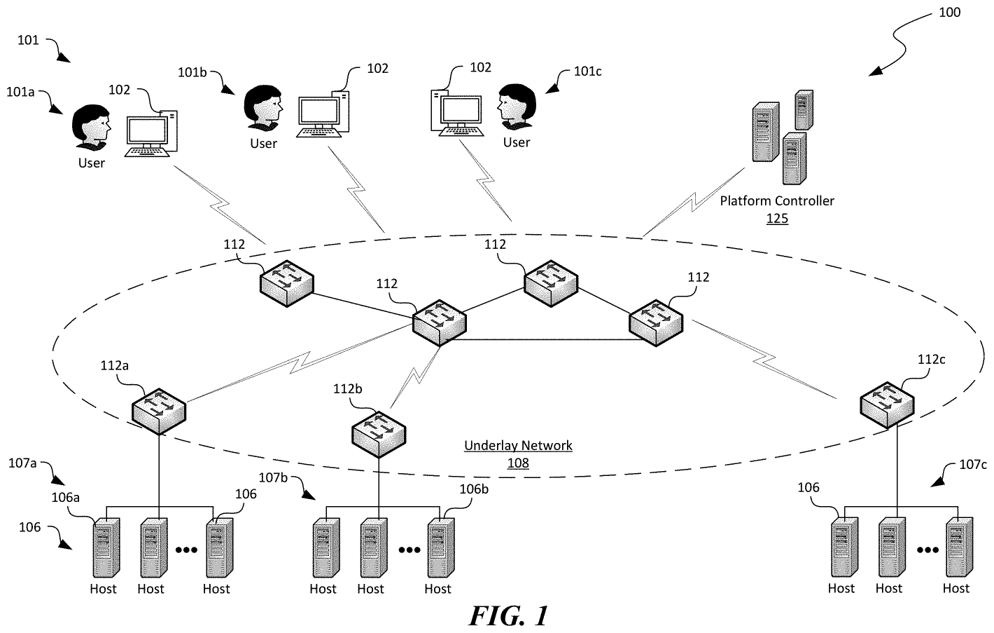

Certain embodiments of systems, devices, components, modules, routines, data structures, and processes for memory inclusivity management are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-5. For example, instead of being implemented in datacenters or other suitable distributed computing systems, aspects of the memory operations management technique disclosed herein can also be implemented on personal computers, smartphones, tablets, or other suitable types of computing devices.

As used herein, the term “distributed computing system” generally refers to an interconnected computer system having multiple network nodes that interconnect a plurality of servers or hosts to one another and/or to external networks (e.g., the Internet). The term “network node” generally refers to a physical network device. Example network nodes include routers, switches, hubs, bridges, load balancers, security gateways, or firewalls. A “host” generally refers to a physical computing device. In certain embodiments, a host can be configured to implement, for instance, one or more virtual machines, virtual switches, or other suitable virtualized components. For example, a host can include a server having a hypervisor configured to support one or more virtual machines, virtual switches, or other suitable types of virtual components. In other embodiments, a host can be configured to execute suitable applications directly on top of an operating system.

A computer network can be conceptually divided into an overlay network implemented over an underlay network in certain implementations. An “overlay network” generally refers to an abstracted network implemented over and operating on top of an underlay network. The underlay network can include multiple physical network nodes interconnected with one another. An overlay network can include one or more virtual networks. A “virtual network” generally refers to an abstraction of a portion of the underlay network in the overlay network. A virtual network can include one or more virtual end points referred to as “tenant sites” individually used by a user or “tenant” to access the virtual network and associated computing, storage, or other suitable resources. A tenant site can host one or more tenant end points (“TEPs”), for example, virtual machines. The virtual networks can interconnect multiple TEPs on different hosts. Virtual network nodes in the overlay network can be connected to one another by virtual links individually corresponding to one or more network routes along one or more physical network nodes in the underlay network. In other implementations, a computer network can only include the underlay network.

Also used herein, the term “near memory” generally refers to memory that is physically proximate to a processor (e.g., a CPU) than other “far memory” at a distance from the processor. For example, near memory can include one or more DDR SDRAM dies that are incorporated into an Integrated Circuit (IC) component package with one or more CPU dies via an interposer and/or through silicon vias. In contrast, far memory can include additional memory on remote computing devices, accelerators, memory buffers, or smart I/O devices that the CPU can interface with via CXL or other suitable types of protocols. For instance, in datacenters, multiple memory devices on multiple servers/server blades may be pooled to be allocatable to a single CPU on one of the servers/server blades. The CPU can access the allocated such far memory via a computer network in datacenters.

In certain implementations, a CPU can include multiple individual processors or cores integrated into an electronic package. The cores can individually include one or more arithmetic logic units, floating-point units, L1/L2 cache, and/or other suitable components. The electronic package can also include one or more peripheral components configured to facilitate operations of the cores. Examples of such peripheral components can include QuickPath® Interconnect controllers, system level cache or SLC (e.g., L3 cache) shared by the multiple cores in the CPU, snoop agent pipeline, SLC controllers configured to manage the SLC, and/or other suitable components.

Also used herein, a “cacheline” generally refers to a unit of data transferred between cache (e.g., L1, L2, or SLC) and memory (e.g., near or far memory). A cacheline can include 32, 64, 128, or other suitable numbers of bytes. A core can read or write an entire cacheline when any location in the cacheline is read or written. In certain implementations, multiple cachelines can be configured to alternately share a memory block at the near memory when the near memory is configured as a swap buffer instead of a dedicated cache for the CPU. The multiple cachelines that alternately share a memory block at the near memory can be referred to as a cache set. As such, at different times, the memory block at the near memory can contain data for one of the multiple cachelines but not the others.

In certain implementations, multiple cachelines of a cache set can be configured (e.g., via hashing) to be stored in a single SLC memory space referred to as SLC slice individually having a data array and a tag array. The data array can be configured to store a copy of data for the individual cachelines while the tag array can include multiple bits configured to indicate certain attributes of the data stored in the corresponding data array. For example, in accordance with embodiments of the disclosed technology, the tag array can be configured to include a validity bit and an inclusivity bit for each cachelines. In other embodiments, the tag array can include the inclusivity bit without the validity bit or having other suitable bits and/or configurations. As described in more detail herein, the inclusivity bits can be configured to monitor inclusivity status in the cache system and modify operations in the computing device accordingly.

FIG. 1 is a schematic diagram illustrating a distributed computing system 100 implementing memory inclusivity management in accordance with embodiments of the disclosed technology. As shown in FIG. 1, the distributed computing system 100 can include an underlay network 108 interconnecting a plurality of hosts 106, a plurality of client devices 102 associated with corresponding users 101, and a platform controller 125 operatively coupled to one another. The platform controller 125 can be a cluster controller, a fabric controller, a database controller, and/or other suitable types of controllers configured to monitor and manage resources and operations of the servers 106 and/or other components in the distributed computing system 100. Even though components of the distributed computing system 100 are shown in FIG. 1, in other embodiments, the distributed computing system 100 can also include additional and/or different components or arrangements. For example, in certain embodiments, the distributed computing system 100 can also include network storage devices, additional hosts, and/or other suitable components (not shown) in other suitable configurations.

As shown in FIG. 1, the underlay network 108 can include one or more network nodes 112 that interconnect the multiple hosts 106 and the client device 102 of the users 101. In certain embodiments, the hosts 106 can be organized into racks, action zones, groups, sets, or other suitable divisions. For example, in the illustrated embodiment, the hosts 106 are grouped into three host sets identified individually as first, second, and third host sets 107a-107c. Each of the host sets 107a-107c is operatively coupled to a corresponding network nodes 112a-112c, respectively, which are commonly referred to as “top-of-rack” network nodes or “TORs.” The TORs 112a-112c can then be operatively coupled to additional network nodes 112 to form a computer network in a hierarchical, flat, mesh, or other suitable topologies. The underlay network can allow communications among hosts 106, the platform controller 125, and the users 101. In other embodiments, the multiple host sets 107a-107c may share a single network node 112 or can have other suitable arrangements.

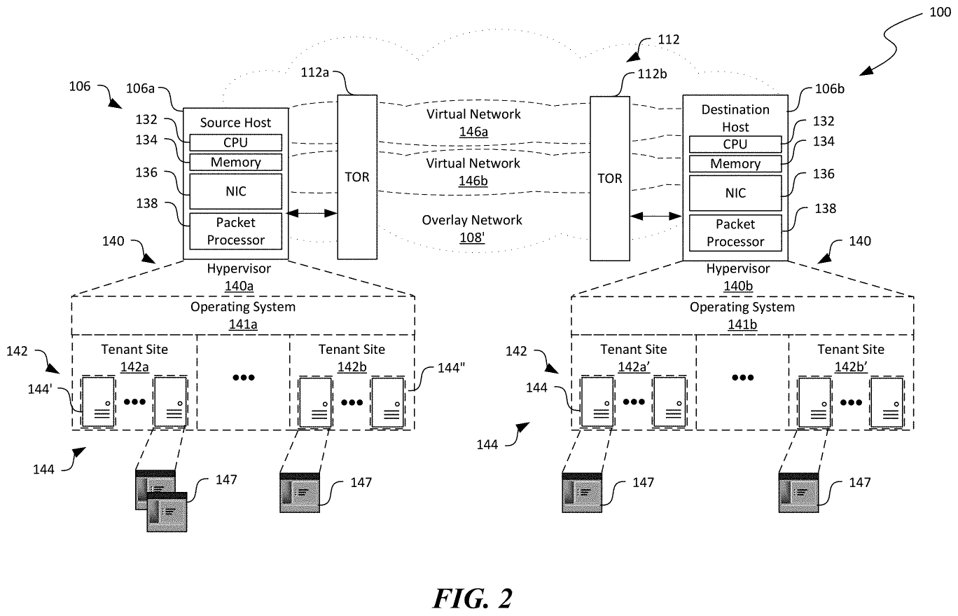

The hosts 106 can individually be configured to provide computing, storage, and/or other suitable cloud or other suitable types of computing services to the users 101. For example, as described in more detail below with reference to FIG. 2, one of the hosts 106 can initiate and maintain one or more virtual machines 144 (shown in FIG. 2) or containers (not shown) upon requests from the users 101. The users 101 can then utilize the provided virtual machines 144 or containers to perform database, computation, communications, and/or other suitable tasks. In certain embodiments, one of the hosts 106 can provide virtual machines 144 for multiple users 101. For example, the host 106a can host three virtual machines 144 individually corresponding to each of the users 101a-101c. In other embodiments, multiple hosts 106 can host virtual machines 144 for the users 101a-101c.

The client devices 102 can each include a computing device that facilitates the users 101 to access computing services provided by the hosts 106 via the underlay network 108. In the illustrated embodiment, the client devices 102 individually include a desktop computer. In other embodiments, the client devices 102 can also include laptop computers, tablet computers, smartphones, or other suitable computing devices. Though three users 101 are shown in FIG. 1 for illustration purposes, in other embodiments, the distributed computing system 100 can facilitate any suitable numbers of users 101 to access cloud or other suitable types of computing services provided by the hosts 106 in the distributed computing system 100.

FIG. 2 is a schematic diagram illustrating certain hardware/software components of the distributed computing system 100 in accordance with embodiments of the disclosed technology. FIG. 2 illustrates an overlay network 108′ that can be implemented on the underlay network 108 in FIG. 1. Though particular configuration of the overlay network 108′ is shown in FIG. 2, In other embodiments, the overlay network 108′ can also be configured in other suitable ways. In FIG. 2, only certain components of the underlay network 108 of FIG. 1 are shown for clarity.

In FIG. 2 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2, the source host 106a and the destination hosts 106b and 106b′ (only the destination hosts 106b is shown with detail components) can each include a CPU 132, a memory 134, a network interface card 136, and a packet processor 138 operatively coupled to one another. In other embodiments, the hosts 106 can also include input/output devices configured to accept input from and provide output to an operator and/or an automated software controller (not shown), or other suitable types of hardware components. In further embodiments, certain components, such as the packet processor 138 may be omitted from one or more of the hosts 106.

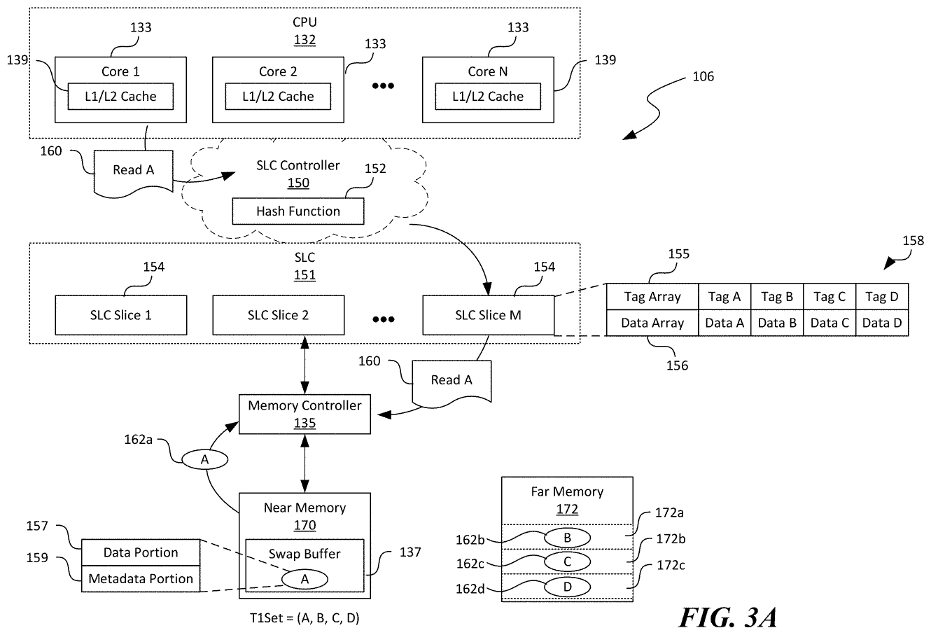

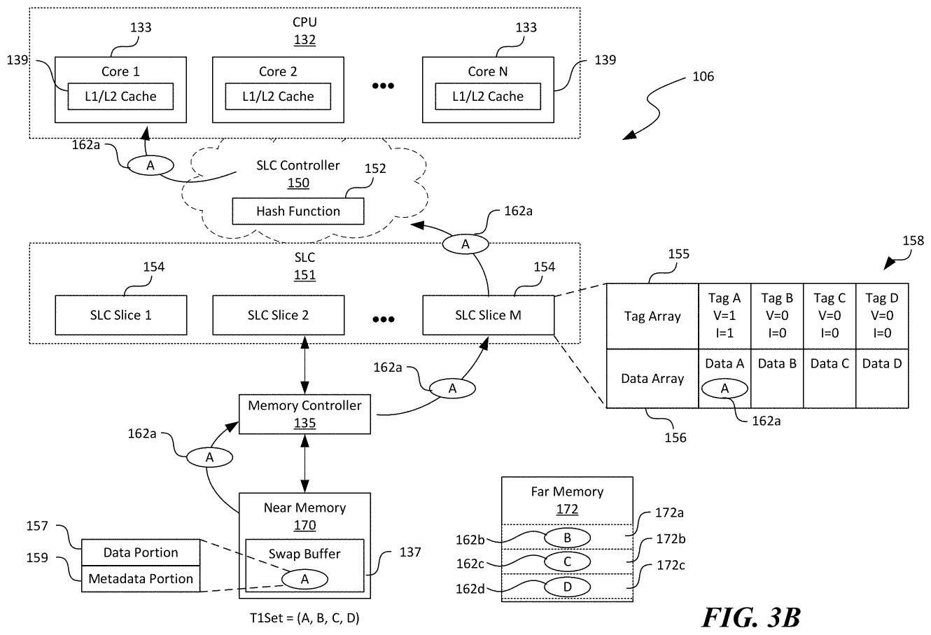

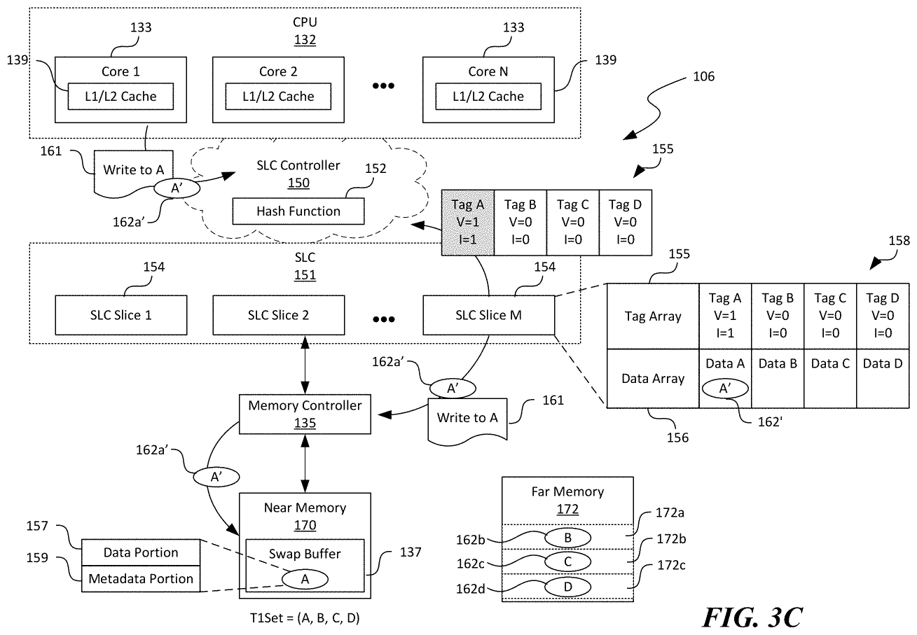

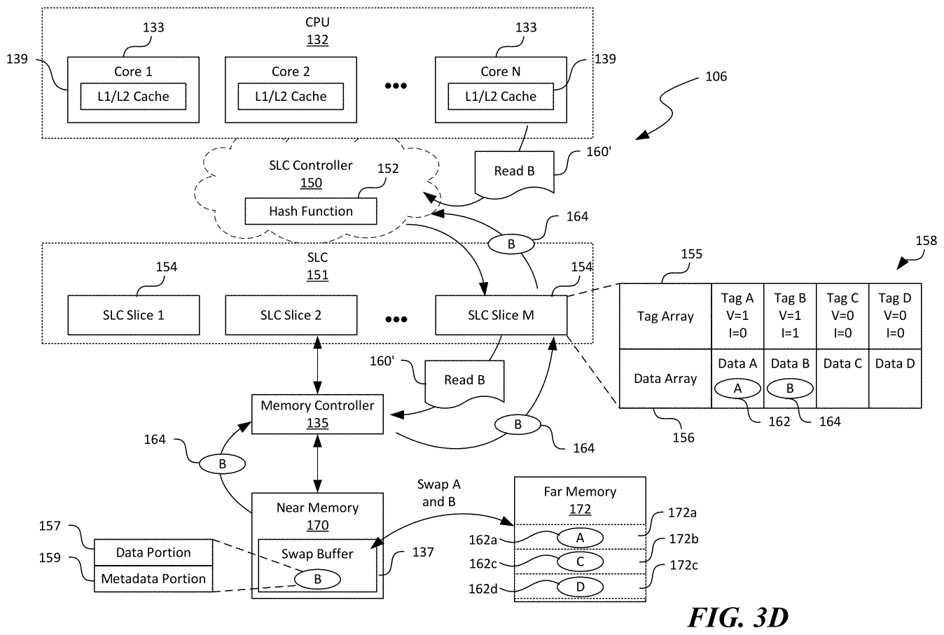

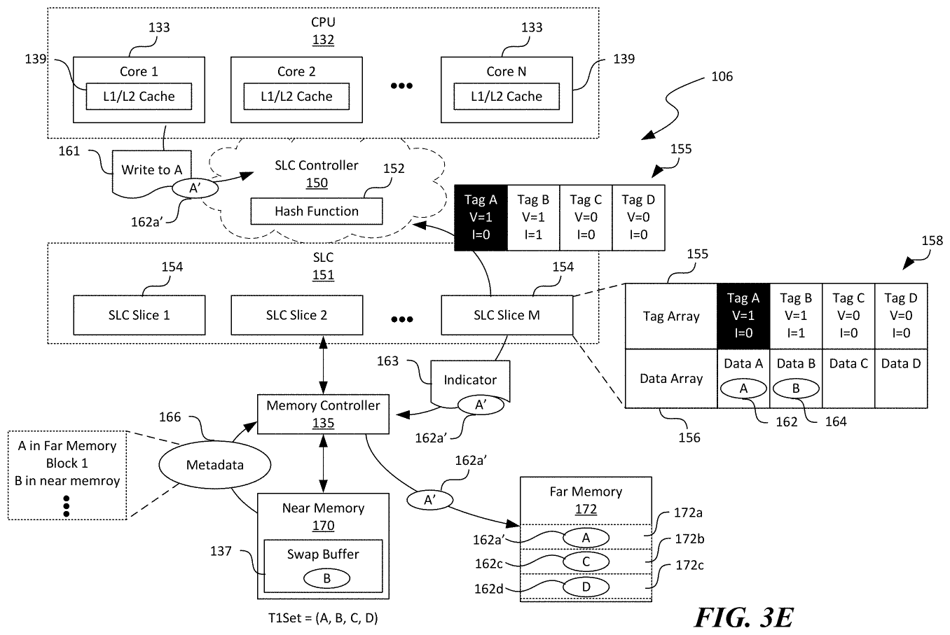

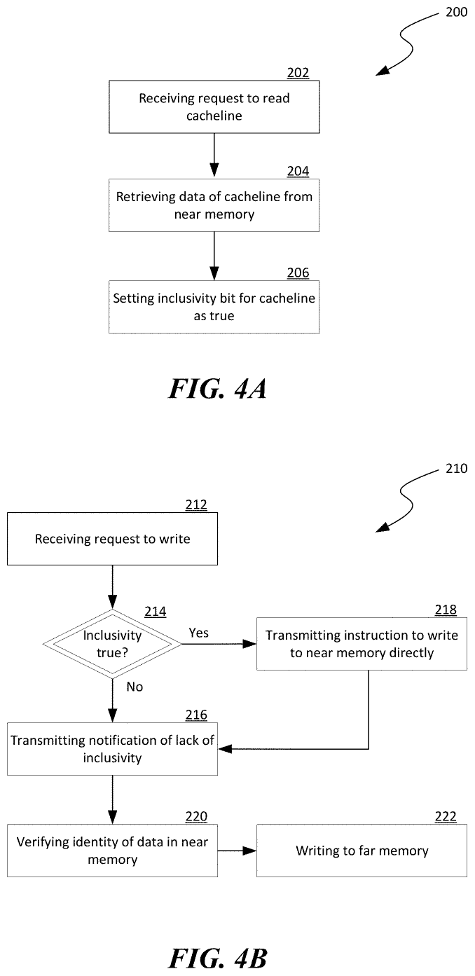

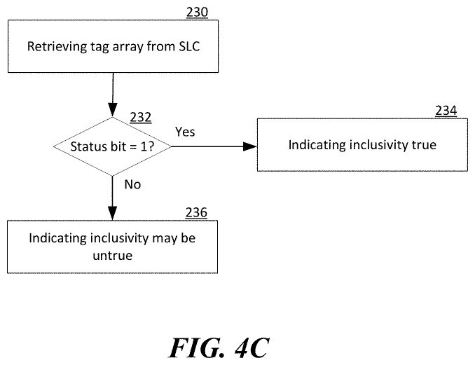

The CPU 132 can include a microprocessor, caches, and/or other suitable logic devices. The memory 134 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the CPU 132 (e.g., instructions for performing the methods discussed below with reference to FIGS. 4A-4C). Certain example configurations of the CPU 132 and the memory 134 are described in more detail below with reference to FIGS. 3A-3E. Though only one CPU 132 and one memory 134 are shown in the individual hosts 106 for illustration in FIG. 2, in other embodiments, the individual hosts 106 can include two, four, six, eight, or any other suitable number of CPUs 132 and/or memories 134.

The source host 106a and the destination host 106b can individually contain instructions in the memory 134 executable by the CPUs 132 to cause the individual CPUs 132 to provide a hypervisor 140 (identified individually as first and second hypervisors 140a and 140b) and an operating system 141 (identified individually as first and second operating systems 141a and 141b). Even though the hypervisor 140 and the operating system 141 are shown as separate components, in other embodiments, the hypervisor 140 can operate on top of the operating system 141 executing on the hosts 106 or a firmware component of the hosts 106.

The hypervisors 140 can individually be configured to generate, monitor, terminate, and/or otherwise manage one or more virtual machines 144 organized into tenant sites 142. For example, as shown in FIG. 2, the source host 106a can provide a first hypervisor 140a that manages first and second tenant sites 142a and 142b, respectively. The destination host 106b can provide a second hypervisor 140b that manages first and second tenant sites 142a′ and 142b′, respectively. The hypervisors 140 are individually shown in FIG. 2 as a software component. However, in other embodiments, the hypervisors 140 can be firmware and/or hardware components. The tenant sites 142 can each include multiple virtual machines 144 for a particular tenant (not shown). For example, the source host 106a and the destination host 106b can both host the tenant site 142a and 142a′ for a first tenant 101a (FIG. 1). The source host 106a and the destination host 106b can both host the tenant site 142b and 142b′ for a second tenant 101b (FIG. 1). Each virtual machine 144 can be executing a corresponding operating system, middleware, and/or applications.

Also shown in FIG. 2, the distributed computing system 100 can include an overlay network 108′ having one or more virtual networks 146 that interconnect the tenant sites 142a and 142b across multiple hosts 106. For example, a first virtual network 142a interconnects the first tenant sites 142a and 142a′ at the source host 106a and the destination host 106b. A second virtual network 146b interconnects the second tenant sites 142b and 142b′ at the source host 106a and the destination host 106b. Even though a single virtual network 146 is shown as corresponding to one tenant site 142, in other embodiments, multiple virtual networks 146 (not shown) may be configured to correspond to a single tenant site 146.

The virtual machines 144 can be configured to execute one or more applications 147 to provide suitable cloud or other suitable types of computing services to the users 101 (FIG. 1). For example, the source host 106a can execute an application 147 that is configured to provide a computing service that monitors online trading and distribute price data to multiple users 101 subscribing to the computing service. The virtual machines 144 on the virtual networks 146 can also communicate with one another via the underlay network 108 (FIG. 1) even though the virtual machines 144 are located on different hosts 106.

Communications of each of the virtual networks 146 can be isolated from other virtual networks 146. In certain embodiments, communications can be allowed to cross from one virtual network 146 to another through a security gateway or otherwise in a controlled fashion. A virtual network address can correspond to one of the virtual machines 144 in a particular virtual network 146. Thus, different virtual networks 146 can use one or more virtual network addresses that are the same. Example virtual network addresses can include IP addresses, MAC addresses, and/or other suitable addresses. To facilitate communications among the virtual machines 144, virtual switches (not shown) can be configured to switch or filter packets directed to different virtual machines 144 via the network interface card 136 and facilitated by the packet processor 138.

As shown in FIG. 2, to facilitate communications with one another or with external devices, the individual hosts 106 can also include a network interface card (“NIC”) 136 for interfacing with a computer network (e.g., the underlay network 108 of FIG. 1). A NIC 136 can include a network adapter, a LAN adapter, a physical network interface, or other suitable hardware circuitry and/or firmware to enable communications between hosts 106 by transmitting/receiving data (e.g., as packets) via a network medium (e.g., fiber optic) according to Ethernet, Fibre Channel, Wi-Fi, or other suitable physical and/or data link layer standards. During operation, the NIC 136 can facilitate communications to/from suitable software components executing on the hosts 106. Example software components can include the virtual switches 141, the virtual machines 144, applications 147 executing on the virtual machines 144, the hypervisors 140, or other suitable types of components.

In certain implementations, a packet processor 138 can be interconnected to and/or integrated with the NIC 136 to facilitate network traffic operations for enforcing communications security, performing network virtualization, translating network addresses, maintaining/limiting a communication flow state, or performing other suitable functions. In certain implementations, the packet processor 138 can include a Field-Programmable Gate Array (“FPGA”) integrated with the NIC 136.

An FPGA can include an array of logic circuits and a hierarchy of reconfigurable interconnects that allow the logic circuits to be “wired together” like logic gates by a user after manufacturing. As such, a user 101 can configure logic blocks in FPGAs to perform complex combinational functions, or merely simple logic operations to synthetize equivalent functionality executable in hardware at much faster speeds than in software. In the illustrated embodiment, the packet processor 138 has one interface communicatively coupled to the NIC 136 and another coupled to a network switch (e.g., a Top-of-Rack or “TOR” switch) at the other. In other embodiments, the packet processor 138 can also include an Application Specific Integrated Circuit (“ASIC”), a microprocessor, or other suitable hardware circuitry.

In operation, the CPU 132 and/or a user 101 (FIG. 1) can configure logic circuits in the packet processor 138 to perform complex combinational functions or simple logic operations to synthetize equivalent functionality executable in hardware at much faster speeds than in software. For example, the packet processor 138 can be configured to process inbound/outbound packets for individual flows according to configured policies or rules contained in a flow table such as a MAT. The flow table can contain data representing processing actions corresponding to each flow for enabling private virtual networks with customer supplied address spaces, scalable load balancers, security groups and Access Control Lists (“ACLs”), virtual routing tables, bandwidth metering, Quality of Service (“QoS”), etc.

As such, once the packet processor 138 identifies an inbound/outbound packet as belonging to a particular flow, the packet processor 138 can apply one or more corresponding policies in the flow table before forwarding the processed packet to the NIC 136 or TOR 112. For example, as shown in FIG. 2, the application 147, the virtual machine 144, and/or other suitable software components on the source host 106a can generate an outbound packet destined to, for instance, other applications 147 at the destination hosts 106b and 106b′. The NIC 136 at the source host 106a can forward the generated packet to the packet processor 138 for processing according to certain policies in a flow table. Once processed, the packet processor 138 can forward the outbound packet to the first TOR 112a, which in turn forwards the packet to the second TOR 112b via the overlay/underlay network 108 and 108′.

The second TOR 112b can then forward the packet to the packet processor 138 at the destination hosts 106b and 106b′ to be processed according to other policies in another flow table at the destination hosts 106b and 106b′. If the packet processor 138 cannot identify a packet as belonging to any flow, the packet processor 138 can forward the packet to the CPU 132 via the NIC 136 for exception processing. In another example, when the first TOR 112a receives an inbound packet, for instance, from the destination host 106b via the second TOR 112b, the first TOR 112a can forward the packet to the packet processor 138 to be processed according to a policy associated with a flow of the packet. The packet processor 138 can then forward the processed packet to the NIC 136 to be forwarded to, for instance, the application 147 or the virtual machine 144.

In certain embodiments, the memory 134 can include both near memory 170 and far memory 172 (shown in FIGS. 3A-3E). The near memory 170 can be a very high-speed memory that acts as a buffer between the far memory and the CPU 132 to hold frequently used cachelines and instructions for immediate availability to the CPU 132. For example, certain computers can include Double Data Rate (DDR) Synchronous Dynamic Random-Access Memory (SDRAM) packaged with the CPU 132 as cache for the CPU 132. In addition to the near memory 170, the CPU 132 can also interface with the far memory 172 via Compute Express Link (CXL) or other suitable types of interface protocols.

In certain implementations, L1, L2, SLC, and the near memory 170 can form a cache system with multiple levels of caches in a hierarchical manner. For example, a core in the CPU 132 can attempt to locate a cacheline in L1, L2, SLC, and the near memory 170 in a sequential manner. However, when the near memory 170 is configured as a swap buffer for the far memory 172 instead of being a dedicated cache memory for the CPU 132, maintaining inclusivity in the cache system may be difficult. One solution for the foregoing difficulty is to configure the cache system to enforce inclusivity in all levels of the caches via back invalidation. Such invalidation though can introduce substantial operational complexity and increase execution latency because a frequently used cacheline may be invalidated due to read/write operations in the swap buffer. Thus, enforcing inclusivity in the host 106 may negatively impact system performance.

Several embodiments of the disclosed technology can address the foregoing impact on system performance when implementing the near memory as a swap buffer in the computer device. In certain embodiments, sections of data (e.g., one or more cachelines) that alternately share a memory block of the near memory 170 can be grouped into a dataset or cache set. A hash function can be implemented at, for example, a SLC controller such that all cachelines in a cache set is stored in a single SLC slice. During operation, the SLC controller can be configured to track a status of inclusivity in the cache system when reading or writing data to the cachelines and modifying operations in the cache system in accordance with the status of the inclusivity in the cache system, as described in more detail below with reference to FIGS. 3A-3E.

FIGS. 3A-3E are schematic diagrams illustrating certain hardware/software components of the distributed computing system of FIG. 1 during example operation stages in accordance with embodiments of the disclosed technology. As shown in FIG. 3A, the host 106 can include a CPU 132, a SLC controller 150, SLC 151, a memory controller 135, a near memory 170, and a far memory 172 operatively coupled to one another. Though particular components are shown in FIG. 3A, in other embodiments, the host 106 can also include additional and/or different components.

In the illustrated embodiment, the CPU 132 can include multiple cores 133 (illustrated as Core 1, Core 2, . . . , Core N) individually having L1/L2 cache 139. The host 106 can also include a SLC controller 150 operatively coupled to the CPU 132 and configured to manage operations of SLC 151. In the illustrated embodiment, the SLC 151 is partitioned into multiple SLC slices 154 (illustrated as SLC Slice 1, SLC Slice 2, . . . , SLC Slice M) individually configured to contain data and metadata of one or more datasets such as cache sets 158. Each cache set 158 can include a tag array 155 and a data array 156 (only one cache set 158 is illustrated for brevity). Though only one cache set 158 is shown as being stored at SLC Slice M in FIG. 3A, in other embodiments, each SLC slice 154 can store two three, or any suitable numbers of cache sets 158.

In certain implementations, the memory controller 135 can be configured to operate the near memory 170 as a swap buffer 137 for the far memory 172 instead of being a dedicated cache memory for the CPU 132. As such, the CPU 132 can continue caching data in the near memory 170 while the near memory 170 and the far memory 172 are exposed to the operating system 141 (FIG. 2) as addressable system memory. A ratio of storage space between near memory 170 and far memory 172 can be flexible. The ratio between near memory 170 and far memory 172 can be one to any integer greater than or equal to one. In one example, a range of system memory address can be covered by a combination of near memory 170 and far memory 172 in a ratio of one to three. As such, the range of system memory can be divided into four sections, e.g., A, B, C, and D (referred to as a “T1set”). Each section can include a data portion 157 (e.g., 512 bits) and a metadata portion 159 (e.g., 128 bits) that can be alternately stored in the swap buffer 137 in the near memory 170. The data portion 157 can be configured to contain data representing user data or instructions executed in the host 106. The metadata portion 159 can include data representing various attributes of the data in the data portion 156. For instance, the metadata portion 159 can include error checking and correction bits or other suitable types of information.

In certain implementations, several bits in the metadata portion 159 in the near memory 170 can be configured to indicate (1) which section of the range of system memory the near memory 170 current holds; and (2) locations of additional sections of the range of system memory in the far memory 172. In the example with four sections of system memory, eight bits in the metadata portion 159 in the near memory 170 can be configured to indicate the foregoing information. For instance, a first pair of first two bits can be configured to indicate which section is currently held in the near memory 170 as follows:

| Bit 1 | Bit 2 | Section ID |
|---|---|---|
| 0 | 0 | A |
| 0 | 1 | B |
| 1 | 0 | C |
| 1 | 1 | D |

As such, the memory controller 135 can readily determine that the near memory 170 contains data from section A of the system memory when the Bit 1 and Bit 2 contains zero and zero, respectively, as illustrated in FIG. 3A.

While the first two bits correspond to the near memory 170, the additional six bits can be subdivided into three pairs individually corresponding to a location in the far memory 172. For instance, the second, third, and four pairs can each correspond to a first, second, or third locations 172a-172c in the far memory 172, as follows:

| | |
|---|---|
| First pair (Bit 1 and Bit 2) | Near memory |
| Second pair (Bit 3 and Bit 4) | First location in far memory |
| Third pair (Bit 5 and Bit 6) | Second location in far memory |
| Fourth pair (Bit 7 and Bit 8) | Third location in far memory |

As such, the memory controller 135 can readily determine where data from a particular section of the system memory is in the far memory 172 even though the data is not currently in the near memory 170. For instance, when the second pair (i.e., Bit 3 and Bit 4) contains (1, 1), the memory controller 135 can be configured to determine that data corresponding to Section D of the system memory is in third location 172c in the far memory 172. When the third pair (i.e., Bit 5 and Bit 6) contains (1, 0), the memory controller 135 can be configured to determine that data corresponding to Section C of the system memory is in second location 172b in the far memory 172. When the fourth pair (i.e., Bit 7 and Bit 8) contains (0, 1), the memory controller 135 can be configured to determine that data corresponding to Section B of the system memory is in the first location 172a in the far memory 172, as illustrated in FIG. 3A.

Using the data from the metadata portion 159 in the near memory 170, the memory controller 135 can be configured to manage swap operations between the near memory 170 and the far memory 172 using the near memory 170 as a swap buffer 137. For example, during a read operation, the CPU 132 can issue a command to the memory controller 135 to read data corresponding to section A when such data is not currently residing in the SLC 151, L1, or L2 cache. In response, the memory controller 135 can be configured to read from the near memory 170 to retrieve data from both the data portion 157 and the metadata portion 159 of the near memory 170. The memory controller 135 can then be configured to determine which section of the system memory the retrieved data corresponds to using the tables above, and whether the determined section matches a target section to be read. For example, when the target section is section A, and the first two bits from the metadata portion 159 contains (0, 0), then the memory controller 135 can be configured to determine that the retrieved data is from section A (e.g., “A data 162a”). Thus, the memory controller 135 can forward the retrieved A data 162a to a requesting entity, such as an application executed by the CPU 132.

On the other hand, when the first two bits from the metadata portion contains (0, 1) instead of (0, 0), the memory controller 135 can be configured to determine that the retrieved data belongs to section B (referred to as “B data 162b”), not A data 162a. The memory controller 135 can then continue to examine the additional bits in the metadata portion 159 to determine which pair of bits contains (0, 0). For example, when the second pair (Bit 3 and Bit 4) from the metadata portion contains (0, 0), then the memory controller 135 can be configured to determine that A data 162a is located at the first location 172a in the far memory 172. In response, the memory controller 135 can be configured to read A data 162a from the first location 172a in the far memory 172 and provide the A data 162a to the requesting entity. The memory controller 135 can then be configured to write the retrieved A data 162a into the near memory and the previously retrieved B data 162b to the first section 172a in the far memory 172. The memory controller 135 can also be configured to modify the bits in the metadata portion 159 in the near memory 170 to reflect the swapping between section A and section B. Though particular mechanisms are described above to implement the swapping operations between the near memory 170 and the far memory 172, in other implementations, the memory controller 135 can be configured to perform the swapping operations in other suitable manners.

As shown in FIG. 3A, the SLC controller 152 can be configured to implement a hash function 152 configured to cause the SLC controller 150 to store all sections of the T1 set in a single SLC slice 154 (e.g., SLC Slice M in FIG. 3A). In accordance with several embodiments of the disclosed technology, the tag array 155 can be configured to include tags (shown as “Tag A,” “Tag B,” “Tag, C,” and “Tag D”) each having data such as a validity bit and an inclusivity bit (shown in FIG. 3B) for each of the A, B, C, D sections. In other embodiments, the tag array 155 can include the inclusivity bit without the validity bit and/or include other suitable types of data.

Using the inclusivity bits, the SLC controller 150 can be configured to monitor inclusivity status in the cache system such as the swap buffer 137 and modify operations in the host 106 accordingly. For example, as shown in FIG. 3A, upon receiving a request 160 from Core 1 of the CPU 132 to read data A 162a, the SLC controller 150 can first check whether data A 162a is already in the SLC 151. As such, the SLC controller 150 can utilize the hash function 152 to hash at least a portion of the request 160 to determine which SLC slice 154 corresponds to data A 162a. In the illustrated example, SLC Slice M corresponds to data A 162a. Thus, the SLC controller 150 can read SLC Slice M to determine whether a copy of data A 162a already exits. In response to determining that a copy of data A 162a is currently not available in the SLC Slice M, the SLC controller 150 can forward the request 160 to the memory controller 135 to request a copy of data A 162a from the swap buffer 137 in the near memory 170.

Upon receiving the request 160 to read data A 162a, the memory controller 135 can be configured to determine whether data A 162a is currently in the swap buffer 137 using metadata in the metadata portion 159, as described above. In the illustrated example, data A 162a is indeed in the swap buffer 137. As such, the memory controller 135 reads data A 162a from the near memory 170 and transmits data A 162a to the SLC controller 150, as shown in FIG. 3B. As shown in FIG. 3B, upon receiving data A 162a from the memory controller 135, the SLC controller 150 can be configured to store a copy of data A 162a in the data array 156 in SLC slice M and set the validity bit (shown as “V”) and the inclusivity bit (shown as “I”) for section A as true (e.g., set to a value of one). The validity bit indicates that data A 162a stored in the SLC slice M is valid while the inclusivity bit indicates that the swap buffer 137 in the near memory 170 also contains a copy of data A 162a. The SLC controller 150 can also be configured to forward a copy of the data A 162a to Core 1 of the CPU 132 as a response to the request 160 (shown in FIG. 3A).

As shown in FIG. 3C, subsequently, Core 1 can transmit a request 161 to write new data 162a′ of section A to the swap buffer 137. When processing the request 161, the SLC controller 150 can be configured to retrieve the tag array 155 from the SLC slice M and determine whether the inclusivity bit for section A is true. Upon determining that the inclusivity bit for section A is true, as illustrated in the example of FIG. 3C, the SLC controller 150 can be configured to instruct the memory controller 135 to directly write the new data 162a′ for section A to the swap buffer 137 without further verification because inclusivity is maintained.

Under other operational scenarios, however, certain intervening operations may cause the swap buffer 137 to contain data for other sections instead of for section A. For example, as shown in FIG. 3D, after reading data A 162a as shown in FIG. 3B, a process executed by Core N 133 at the CPU 132 can issue another request 160′ to the SLC controller 150 to read data B 162b. In response, the SLC controller 150 can hash the request 160′ to determine that SLC Slice M corresponding to data B 162b and check whether a copy of data B 162b is already available at the SLC Slice M.

In response to determining that data B 162b is currently not available at the SLC Slice M, the SLC controller 150 can be configured to request the memory controller 135 for a copy of data B 162b. In response, memory controller 135 can perform the swap operations described above to read data B 162b from the first location 172a in the far memory 172, store a copy of data B 162b in the swap buffer 137, provide a copy of data B 162b to the SLC controller 150, and write a copy of data A 162a to the first location 172a in the far memory 172. Upon receiving the copy of data B 162b, the SLC controller 150 can be configured to set the validity and inclusivity bits for section B as true while modifying the inclusivity bit for section A to not true, as shown in FIG. 3D. As such, the validity bit for section A indicates that the copy of data A 162a in the SLC Slice M is still valid though the swap buffer 137 at the near memory 170 may not also contain a copy of data A 162a.

As shown in FIG. 3E, after reading data B 162b shown in FIG. 3D, Core 1 can issue the request 161 to write the new data 162a′ to section A. Upon receiving the request 161, the SLC controller 150 can be configured to determine that the inclusivity bit for section A is not true (shown in reverse contrast). As such, the SLC controller 150 can be configured to provide the new data 162a′ for section A to the memory controller 135 along with an indicator 163 indicating that the swap buffer 137 in the near memory 170 may not contain data A 162a. Based on the indicator 163, the memory controller 135 can be configured to perform additional operations such as retrieving metadata 166 from the metadata portion 159 in the swap buffer 137 to determine that data A 162a is currently located in the first location 172a in the far memory 172, as described above. In response, the memory controller 135 can forward the new data 162a′ to the far memory 172 to be stored at the first location 172a in the far memory 172 instead of writing the new data 162a′ to the swap buffer 137 in the near memory 170.

Several embodiments of the disclosed technology above can thus improve system performance of the host 106 when the near memory 170 is used as a swap buffer 137 instead of a dedicated cache for the CPU 132. Using performance simulations, the inventors have recognized that large numbers of operations in a host 106 do not involve intervening read/write operations as those shown in FIGS. 3D and 3E. As such, inclusivity at the multiple levels of cache is often maintained. Thus, by using the inclusivity bit in the tag array 155 to monitor for a status of inclusivity in the cache system, extra read of the metadata 166 in FIG. 3E before write operations by the memory controller 135 can often be avoided. As a result, execution latency and/or other system performance of the computing device can be improved.

FIGS. 4A-4C are flowcharts illustrating certain processes of memory inclusivity management in accordance with embodiments of the disclosed technology. Though embodiments of the processes are described below in the context of the distributed computing system 100 of FIGS. 1-3E, in other embodiments, aspects of the processes can be implemented in computing systems with additional and/or different components.

As shown in FIG. 4A, a process 200 can include receiving, at a SLC controller a request to read a cacheline from near memory at stage 202. The near memory can be configured as a swap buffer for far memory as described with reference to FIG. 3A. The process 200 can then include retrieving data of the cacheline from the near memory at stage 204. The process 200 can further include setting an inclusivity bit for the retrieved cacheline as true at stage 206. The inclusivity bit indicates whether the SLC and the swap buffer in the near memory contains data corresponding to the same cacheline, as described in more detail above with reference to FIG. 3B.

FIG. 4B is a flowchart illustrating a process 210 for writing new data to a cacheline. As shown in FIG. 4B, the process 210 can include receiving a request to write to the cacheline at stage 212. The process 210 then includes a decision stage 214 to determine whether inclusivity related to the cacheline in the cache system is true. Example operations for performing such a determination are described in more detail below with reference to FIG. 4C. In response to determining that inclusivity related to the cacheline in the cache system is true, the process 210 can include transmitting an instruction to write the new data directly to the swap buffer in the near memory at stage 218. Otherwise, the process 210 can include transmitting a notification to a memory controller indicating a lack of inclusivity related to the cacheline at stage 216. The process 210 can further include verifying identity of the data in the swap buffer of the near memory at stage 220 and writing to a location in far memory at stage 222, as described above in more detail with reference to FIG. 3E.

As shown in FIG. 4C, operations for determining whether inclusivity related to the cacheline in the cache system is true can include retrieving a tag array containing inclusivity bits for each section at stage 230. The operations can then include a decision stage to determine whether the inclusivity bit for the cacheline is true. In response to determining that the inclusivity bit is true, the operations proceed to indicating that inclusivity related to the cacheline is true at stage 234. Otherwise, the operations proceed to indicating the inclusivity related to the cacheline is not true at stage 236.

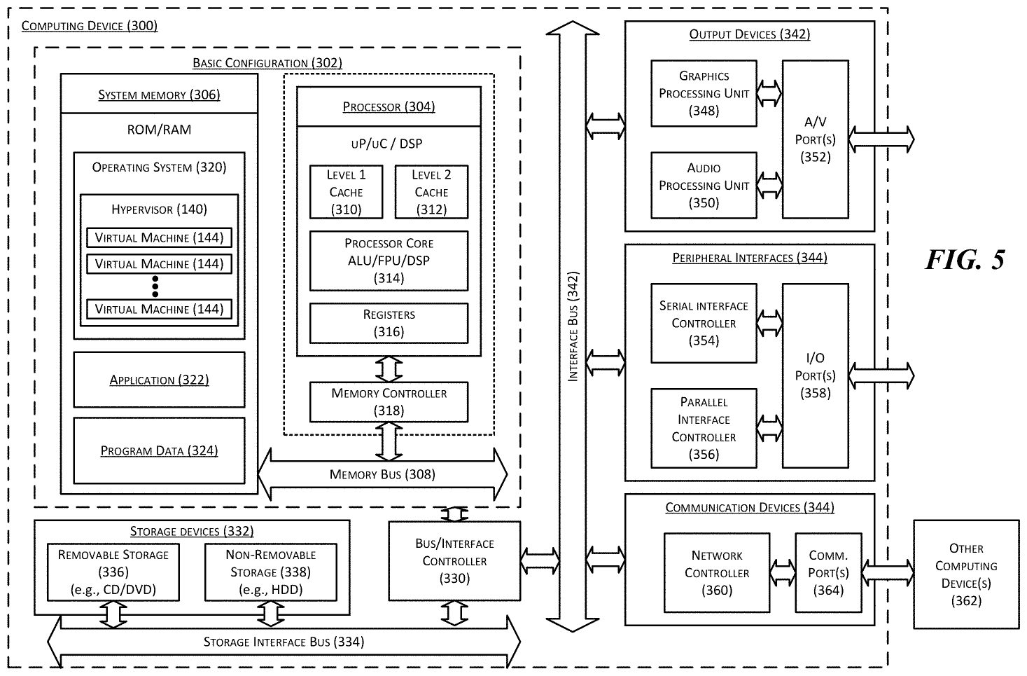

FIG. 5 is a computing device 300 suitable for certain components of the distributed computing system 100 in FIG. 1. For example, the computing device 300 can be suitable for the hosts 106, the client devices 102, or the platform controller 125 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. As shown in FIG. 5, the operating system 320 can include a hypervisor 140 for managing one or more virtual machines 144. This described basic configuration 302 is illustrated in FIG. 5 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable, and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information, and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more NV ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal cacheline Assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in-lieu of the elements of the other embodiments. Accordingly, the technology is not limited except as by the appended claims.

I/We claim:

1. A method of memory inclusivity management in a computing device having a central processing unit (CPU) with multiple cores sharing a system level cache (SLC) managed by a SLC controller, a first memory managed by a memory controller, and a second memory separate from the first memory and interfaced with the CPU, the method comprising:
receiving, at the SLC controller, a request from a core of the CPU to write a block of data corresponding to a first cacheline to a memory block at the first memory configured to cache data for the CPU; and
in response to receiving the request to write from the core, at the SLC controller,
retrieving, from the SLC, metadata corresponding to the first cacheline stored at the SLC, the metadata including a bit encoding a status value indicating whether the memory block at the first memory currently contains data corresponding to the first cacheline;
decoding the status value of the bit in the retrieved metadata corresponding to the first cacheline to determine whether the memory block at the first memory currently contains the data corresponding to the first cacheline or data corresponding to a second cacheline alternately sharing the memory block at the first memory with the first cacheline; and
when the decoded status value indicates that the memory block at the first memory currently contains the data corresponding to the first cacheline, transmitting the block of data to the memory controller along with an instruction to directly write the block of data to the memory block at the first memory.

2. The method of claim 1, further comprising:
when the decoded status value indicates that the memory block at the first memory currently does not contain the data corresponding to the first cacheline, transmitting the block of data to the memory controller along with an indicator indicating that the memory block at the first memory may not currently contain the data corresponding to the first cacheline.

3. The method of claim 1, further comprising:
when the decoded status value indicates that the memory block at the first memory currently does not contain the data corresponding to the first cacheline in the request,
transmitting the block of data to the memory controller along with an indicator indicating that the memory block at the first memory may not currently contain the data corresponding to the first cacheline; and
upon receiving the block of data and the indicator, at the memory controller, determining a location at the second memory currently storing the data of the first cacheline without writing the received block of data to the memory block at the first memory.

4. The method of claim 1, further comprising:
when the decoded status value indicates that the memory block at the first memory currently does not contain the data corresponding to the first cacheline,
transmitting the block of data to the memory controller along with an indicator indicating that the memory block at the first memory may not currently contain the data corresponding to the first cacheline; and
upon receiving the block of data and the indicator, at the memory controller, retrieving data currently stored in the memory block at the first memory;
determining, based on the retrieved data, a location at the second memory currently storing data of the first cacheline; and
forwarding the block of data to be stored at the determined location at the second memory without writing the block of data to the memory block at the first memory.

5. The method of claim 1 wherein:
the request is a first request;
the bit is a first bit of the metadata; and
the method further includes:
receiving, at the SLC controller, a second request to read data of the second cacheline from the memory block of the first memory; and
upon receiving the second request, at the SLC controller,
retrieving a copy of the data of the second cacheline from the memory controller; and
modifying a status value of a second bit of the metadata stored at the SLC to indicate that the memory block at the first memory contains the data of the second cacheline.

6. The method of claim 1 wherein:
the request is a first request;
the bit is a first bit of the metadata; and
the method further includes:
receiving, at the SLC controller, a second request to read data of the second cacheline from the memory block of the first memory; and
upon receiving the second request, at the SLC controller,
retrieving a copy of the data of the second cacheline from the memory controller;
storing the retrieved copy of the data of the second cacheline at the SLC; and
modifying a status value of a second bit of the metadata stored at the SLC to indicate that the memory block at the first memory currently contains the data of the second cacheline.

7. The method of claim 1 wherein:
the request is a first request;
the bit is a first bit of the metadata; and
the method further includes:
receiving, at the SLC controller, a second request to read data of the second cacheline from the memory block of the first memory; and
upon receiving the second request, at the SLC controller, modifying the status value of the first bit of the metadata stored at the SLC to indicate that the memory block at the first memory currently may not contain the data of the first cacheline.

8. The method of claim 1 wherein:
the request is a first request;
the bit is a first bit of the metadata; and
the method further includes:
receiving, at the SLC controller, a second request to read data of a second cacheline from the memory block of the first memory; and
upon receiving the second request, at the SLC controller,
retrieving a copy of the data of the second cacheline from the memory controller;
modifying the status value of the first bit of the metadata stored at the SLC to indicate that the memory block at the first memory currently does not contain the data of the first cacheline; and
modifying a status value of a second bit of the metadata stored at the SLC to indicate that the memory block at the first memory currently contains the data of the second cacheline.

9. The method of claim 1, further comprising:
in response to receiving the request to write from the core, hashing at least a portion of the request such that the data and the metadata of the first cacheline and the second cacheline are stored in a single SLC slice in the SLC.

10. A computing device, comprising:
a central processing unit (CPU) with multiple cores, a system level cache (SLC) shared by the multiple cores, and a SLC controller configured to manage the SLC;
a first memory operatively coupled to the CPU;
a memory controller configured to manage the first memory; and
a second memory separate from the first memory and interfaced with the CPU, wherein the SLC controller including instructions executable to cause the SLC controller to:
receive a request from a core of the CPU to write a block of data corresponding to a first cacheline to a memory block at the first memory configured to cache data for the CPU; and
in response to receiving the request to write from the core,
retrieve, from the SLC, metadata corresponding to the first cacheline stored at the SLC, the metadata including a bit encoding a status value indicating whether the memory block at the first memory currently contains data corresponding to the first cacheline;
decode the status value of the bit in the retrieved metadata corresponding to the first cacheline to determine whether the memory block at the first memory currently contains the data corresponding to the first cacheline or data corresponding to a second cacheline alternately sharing the memory block at the first memory with the first cacheline; and
when the decoded status value indicates that the memory block at the first memory currently contains the data corresponding to the first cacheline, transmit the block of data to the memory controller along with an instruction to directly write the block of data to the memory block at the first memory.

11. The computing device of claim 10 wherein the SLC controller includes additional instructions executable to cause the SLC controller to transmit the block of data to the memory controller along with an indicator indicating that the memory block at the first memory may not currently contain the data corresponding to the first cacheline when the decoded status value indicates that the memory block at the first memory currently does not contain the data corresponding to the first cacheline.

12. The computing device of claim 10 wherein:
the request is a first request;
the bit is a first bit of the metadata; and
the SLC controller includes additional instructions executable to cause the SLC controller to:
receive, at the SLC controller, a second request to read data of the second cacheline from the memory block of the first memory; and
upon receiving the second request,
retrieve a copy of the data of the second cacheline from the memory controller; and
modify a status value of a second bit of the metadata stored at the SLC to indicate that the memory block at the first memory contains the data of the second cacheline.

13. The computing device of claim 10 wherein:
the request is a first request;
the bit is a first bit of the metadata; and
the SLC controller includes additional instructions executable to cause the SLC controller to:
receive, at the SLC controller, a second request to read data of the second cacheline from the memory block of the first memory; and
upon receiving the second request, at the SLC controller,
retrieve a copy of the data of the second cacheline from the memory controller;
store the retrieved copy of the data of the second cacheline at the SLC; and
modify a status value of a second bit of the metadata stored at the SLC to indicate that the memory block at the first memory currently contains the data of the second cacheline.

14. The computing device of claim 10 wherein:
the request is a first request;
the bit is a first bit of the metadata; and
the SLC controller includes additional instructions executable to cause the SLC controller to:
receive, at the SLC controller, a second request to read data of the second cacheline from the memory block of the first memory; and
upon receiving the second request, at the SLC controller, modify the status value of the first bit of the metadata stored at the SLC to indicate that the memory block at the first memory currently may not contain the data of the first cacheline.

15. The computing device of claim 10 wherein:
the request is a first request;
the bit is a first bit of the metadata; and
the SLC controller includes additional instructions executable to cause the SLC controller to:
receive, at the SLC controller, a second request to read data of a second cacheline from the memory block of the first memory; and
upon receiving the second request, at the SLC controller,
modify the status value of the first bit of the metadata stored at the SLC to indicate that the memory block at the first memory currently does not contain the data of the first cacheline; and
modify a status value of a second bit of the metadata stored at the SLC to indicate that the memory block at the first memory currently contains the data of the second cacheline.

16. The computing device of claim 10 wherein the SLC controller includes additional instructions executable to cause the SLC controller to hash at least a portion of the request such that the data and the metadata of the first cacheline and the second cacheline are stored in a single SLC slice in the SLC in response to receiving the request to write from the core.

17. A method of memory inclusivity management in a computing device having a central processing unit (CPU) with multiple cores sharing a system level cache (SLC) managed by a SLC controller, a first memory managed by a memory controller, and a second memory separate from the first memory and interfaced with the CPU, the method comprising:
receiving, at the SLC controller, a request from a core of the CPU to write a block of data corresponding to a system memory address to a memory block at the first memory; and
in response to receiving the request to write from the core, at the SLC controller,
retrieving, from the SLC, metadata including one or more bits individually encoding a status value indicating whether the memory block at the first memory currently contains data corresponding to the system memory address or data corresponding to one or more additional system memory addresses alternately sharing the memory block at the first memory;
determining, based on the retrieved metadata from the SLC, whether the memory block at the first memory currently contains the data corresponding to the system address in the request; and
in response to determining that the memory block at the first memory currently contains the data corresponding to the system address, transmitting the block of data to the memory controller along with an instruction to directly write the block of data to the memory block at the first memory.

18. The method of claim 17, further comprising:
in response to determining that the memory block at the first memory currently does not contain the data corresponding to the system memory, transmitting the block of data to the memory controller along with an indicator indicating that the memory block at the first memory may not currently contain the data corresponding to the system memory in the request to write.

19. The method of claim 17 wherein:
the request is a first request;
the system address is a first system address; and
the method further includes:
receiving, at the SLC controller, a second request to read data of a second system address from the memory block of the first memory; and
upon receiving the second request, at the SLC controller,
retrieving a copy of the data of the second system address from the memory controller; and
modifying a value of one of the one or more bits corresponding to the second memory address in the metadata to indicate that the memory block at the first memory contains the data of the second memory address.

20. The method of claim 17 wherein:
the request is a first request;
the system address is a first system address; and
the method further includes:
receiving, at the SLC controller, a second request to read data of a second memory address from the memory block of the first memory; and
upon receiving the second request, at the SLC controller,
modifying the status value of the first bit of the metadata stored at the SLC to indicate that the memory block at the first memory currently does not contain the data of the first cacheline; and
modifying a status value of a second bit of the metadata stored at the SLC to indicate that the memory block at the first memory currently contains the data of the second cacheline.
